(19) United States
(12) Patent Application Publication
(10) Pub. No.: US 2010/0268357 A1
(43) Pub. Date: Oct. 21, 2010

(54) COMPILER FOR DRILLING MACHINE

(75) Inventor: YUEH-HSUN KING, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/434,683

(22) Filed: May 3, 2009

(30) Foreign Application Priority Data
Apr. 21, 2009 (CN) 200910301708.X

(51) Int. Cl. G06F 9/45; G05B 19/05

(52) U.S. Cl. 700/86; 717/140

(57) ABSTRACT

A compiler for a drilling machine includes an operation module, an operation parameter module, a process setting module, a control unit setting module, and a cutting tool module. The operation module stores a plurality of action codes corresponding to drilling tasks, and transmits the action codes of selected drilling tasks to the process setting module. The operation parameter module stores a plurality of working parameters corresponding to the plurality of drilling tasks. The control unit setting module stores a plurality of object codes corresponding to the plurality of drilling tasks. The cutting tool module calculates information of operation cutting tools. The process setting module generates a source program according to the action codes of the selected drilling tasks. When the compiler is executed, the source program is translated to a control program based on the object codes of the selected drilling tasks and the information of the operation cutting tools.

### BACKGROUND

1. Technical Field

The present disclosure relates to compilers, and particularly to a compiler for a drilling machine.

2. Description of the Related Art

Generally, there are three kinds of tasks for dealing with cutting tools of a drilling machine: cutting tool loading, cutting tool unloading, and cutting tool changing. Accordingly, three kinds of control programs corresponding to the three kinds of tasks need to be compiled, according to predetermined codes and parameters in a specification of a drilling machine, which is inconvenient.

### BRIEF DESCRIPTION OF THE DRAWINGS

FIG. 1 is a block diagram of an exemplary embodiment of a compiler for a drilling machine.

FIG. 2 is a schematic diagram of an operation interface of the compiler of FIG. 1, in accordance with an exemplary embodiment.

FIG. 3 is a table of a plurality of icons and a plurality of corresponding drilling operations, in accordance with an exemplary embodiment.

FIG. 4 is a block diagram of the compiler of FIG. 1 applied in a computer, in accordance with an exemplary embodiment.

### DETAILED DESCRIPTION

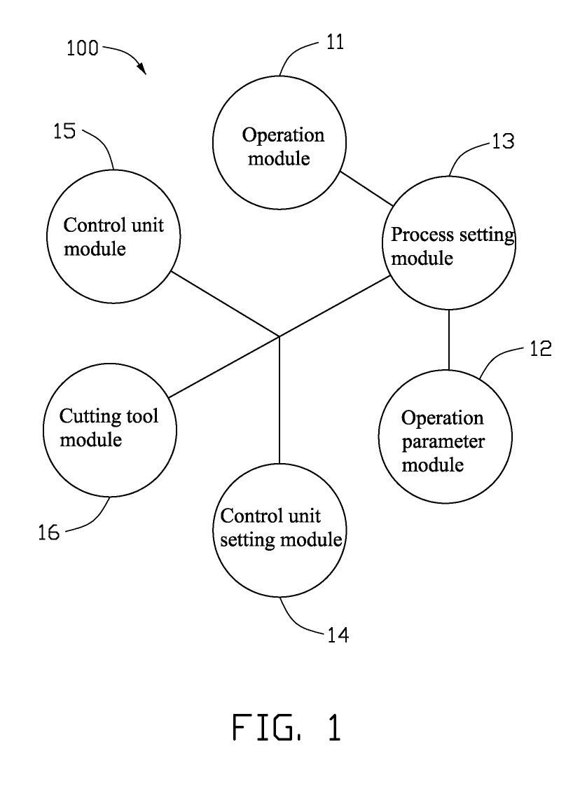

Referring to FIG. 1, an exemplary embodiment of a compiler 100 for a drilling machine includes an operation module 11, an operation parameter module 12, a process setting module 13, a control unit setting module 14, a control unit module 15 and a cutting tool module 16. The operation module 11 stores a plurality of source codes, such as action codes, corresponding to a plurality of drilling operations, and transmits the source codes of selected drilling operations to the process setting module 13.

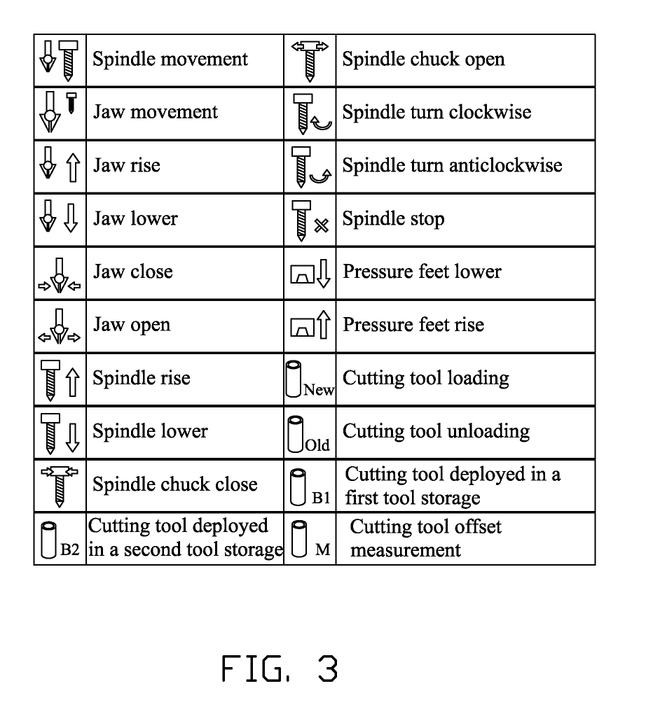

Referring to FIG. 3, the plurality of drilling machine operations includes 20 kinds of drilling operations: spindle movement, jaw movement, jaw rise, jaw lower, jaw close, jaw open, spindle rise, spindle lower, spindle chuck close, spindle chuck open, spindle turn clockwise, spindle turn anticlockwise, spindle stop, pressure feet lower, pressure foot rise, cutting tool loading, cutting tool unloading, cutting tool deployed in a first tool storage, cutting tool deployed in a second tool storage, and cutting tool offset measurement, wherein the spindle movement and the jaw movement belong to a movement drilling category, and are referred as the movement drilling operations; the other operations belong to an assistance drilling category, and are referred as assistance drilling operations for assisting the movement drilling operations to finish a drilling task.

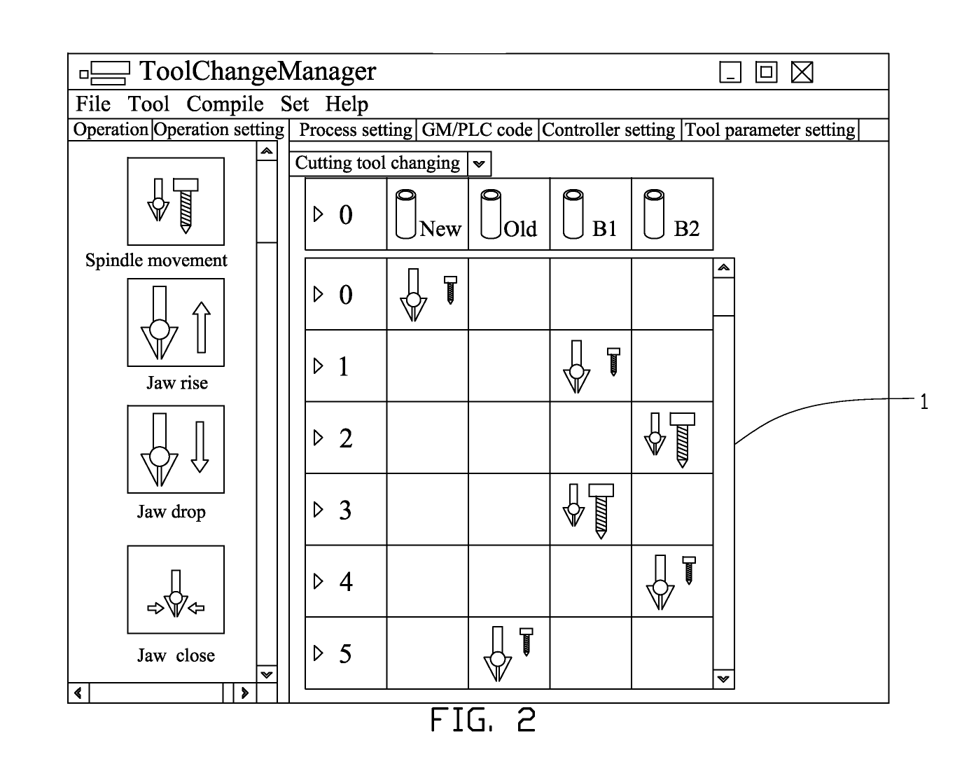

Additionally, the 20 kinds of drilling operations can also be classified according to location operations and action operations, wherein the cutting tool loading, cutting tool unloading, cutting tool deployed in a first tool storage, cutting tool deployed in a second tool storage, and cutting tool offset measurement all are referred to as location operations, and belong to a location operation category; and the other operations are referred as action operations, and belong to the action operation category. The location operations are used for indicating locations of the action operations. A corresponding icon of each drilling operation is also shown in FIG. 3. All drilling operation icons are listed below the operation menu shown as FIG. 2. The operation module 11 transmits the source codes corresponding to the selected drilling operations to the process setting module 13, when the icons of the selected drilling operations are selected.

The operation parameter module 12 stores a plurality of working parameters of the 20 kinds of drilling operations, such as Z coordinate values for spindle rise and lower, speeds for the spindle turn clockwise and anticlockwise. The plurality of working parameters of the 20 kinds of drilling operations may be input by an operator through an operation setting menu in FIG. 2 according to specifications of the drilling machine being used.

The control unit setting module 14 stores a plurality of object codes, such as grid matrix (GM) codes and programmable logic controller (PLC) codes, for the 20 kinds of drilling operations. For example, if the GM codes corresponding to spindle rotation clockwise and spindle rise are M03 and M05 in the specification, then those code associations need to be input in GM/PLC code menu depicted in FIG. 2.

Whereas the setting module 14 is used for manually setting the code associations, the control unit module 15 stores predetermined associations of the GM and PLC codes of each drilling operation corresponding to a drilling machine type preset. When an icon of one of the preset drilling machine types in a controller setting menu (shown in FIG. 2) is selected, the control module 15 automatically provides the relationship between GM, PLC codes and each drilling operation. It should be understood that the control module 15 is an accessorial module for the control unit setting module 14, and can be omitted.

The cutting tool module 16 is to calculate the information of the operation cutting tool according to preset tool operation parameters in a tool parameter setting menu in FIG. 2. The tool operation parameters include the number of longitudinal and transverse tool sets, the transverse and longitudinal tool set intervals, tool set arrangement type, the number of cutting tools in each tool set, x-coordinate and y-coordinate of a first cutting tool in each tool set, transverse and longitudinal cutting tool intervals, and the number of the transverse and longitudinal cutting tools.

The process setting module 13 is to generate a source program according to the source codes of the selected drilling operations. Drilling operations corresponding to each of the three kinds of tool tasks can be selected in two ways. First, referred to a fast setting manner, drilling operations are selected from the movement operation category. Second, referred to a normal setting manner, drilling operations are selected from the 20 kinds of operations.

The process settings for cutting tool changing, i.e. replacing an old tool by a new tool, in the fast setting manner and in the normal setting manner are described as follow. In the fast setting manner, shown as in the operation region 1 in FIG. 2, the icon of the jaw movement is deployed below the icon of the cutting tool unloading to indicate that the jaw moves to the location of a new cutting tool to get the new cutting tool. The icon of the jaw movement is deployed below the icon of the cutting tool deployed in a first tool storage to indicate that the jaw moves to the location of the first tool storage to deploy the new cutting tool in the first tool storage.

The icon of the spindle movement is deployed below the icon of the cutting tool deployed in a second tool storage, to indicate that the spindle moves to the location of the second tool storage to deploy an old cutting tool in the second tool storage. The icon of the spindle movement is deployed below the icon of the cutting tool deployed in a first tool storage, to indicate that the spindle moves to the location of the first tool storage to load the new cutting tool. The icon of the jaw movement is deployed below the icon of the cutting tool deployed in a second tool storage, to indicate that the jaw moves to the location of the second tool storage to get the old cutting tool. The icon of the jaw movement is deployed below the icon of the cutting tool return, to indicate that the jaw deploys the old cutting tool at a location of a preset tool set.

In the normal process setting manner, the icons of the jaw movement, jaw lower, jaw open, jaw close, jaw rise, and spindle rise are deployed below the icon of the cutting tool unloading to indicate that the jaw moves to the location of the new cutting tool to load the new cutting tool. The icons of the jaw movement, spindle lower, jaw open, and spindle rise are deployed below the icon of the cutting tool deployed in a first tool storage to indicate that the jaw moves to the location of the first tool storage to deploy the new cutting tool in the first tool storage.

The icons for spindle lower, jaw open, spindle rise are deployed below the icon of the cutting tool deployed in a second tool storage to indicate that the spindle deploys the old cutting tool in the second tool storage. The icons of the spindle movements, spindle chuck open, spindle chuck close, and spindle turn clockwise are deployed below the icon of the cutting tool deployed in a first tool storage to indicate that the spindle install the new cutting tool. The icons of the jaw movement, jaw close, jaw rise, and spindle rise are deployed below the icon of the cutting tool deployed in a second tool storage to indicate that the jaw get the old cutting tool. The icons of the jaw movement, jaw lower, jaw open, and jaw rise are deployed below the icon of the cutting tool return to indicate that the jaw deploys the old cutting tool on the location of the preset tool set. In this way, comparing with the normal setting manner, the fast setting manner greatly simplifies the operator's workload.

The operation module 11 is to transmit source codes corresponding the selected drilling operations to the process setting module 13 when the icons of the selected drilling operation are selected. After the icons of the selected drilling operation are deployed in the operation region 1, the operation module 11 associates the location drilling operations with the corresponding action drilling operations based on the abscissas of the location and action drilling operations. For example, if the icon of the jaw movement is deployed below the icon of the cutting tool unloading, the jaw movement and the cutting tool unloading have the same abscissas, and have the same location.

The operation module 11 further determines the sequence of the source codes for the selected drilling operations in the source program based on the ordinates of the icons of the selected drilling operations. Because the drilling operations in the fast setting manner is selected from the movement operation category, the process setting module 13 needs to complement a plurality of assistance drilling operations corresponding to each location drilling operations based on a preset processing program stored in the process setting module 13. Because the assistance drilling operations corresponding to each location drilling operation are different for the three kinds of tool tasks, the tool tasks need to be preset in a process setting menu in FIG. 2 to indicate the preset processing program, to constitute correct relationship between assistance drilling operations and each location drilling operation for the preset task.

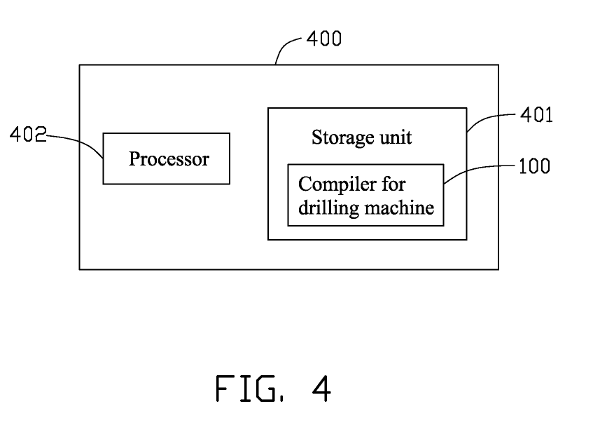

Referring to FIG. 4, the compiler 100 is stored in a storage unit 401 of a computer 400, and is executed by a processor 402 of the computer 400. When the compiler 100 is executed, the source program generated by the process setting module 13 is translated to an object program based on the object codes of the selected drilling operations in the control unit setting module 14, and the information of the operation cutting tools in the cutting tool module 16.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A compiler for a drilling machine, stored in a memory unit and executed by a processor, the compiler comprising:
an operation module to store a plurality of source codes corresponding to a plurality of drilling operations of the drilling machine, and to output the source codes of selected drilling operations;
an operation parameter module to store a plurality of working parameters corresponding to the plurality of drilling operations;
a process setting module to receive the source codes of the selected drilling operations, and to generate a source program according to the source codes and working parameters of the selected drilling operations;
a control unit setting module to store a plurality of object codes corresponding to the plurality of drilling operations; and
a cutting tool module to calculate information of a plurality of operation cutting tools;
wherein the source codes are translated to an object program based on the object codes of the selected drilling operations and the information of the plurality of operation cutting tools.

2. The compiler of claim 1, wherein the object codes are used for controlling the drilling machine to achieve three tool tasks, wherein the tool tasks comprise cutting tool changing, cutting tool load, and cutting tool unloading.

3. The compiler of claim 1, wherein the information of the plurality of operation cutting tools are calculated based on a plurality of tool operation parameters, wherein the plurality of tool operation parameters include the number of longitudinal and transverse tool sets, the transverse and longitudinal tool set intervals, tool set arrangement types, the number of cutting tool in each tool set, x-coordinate and y-coordinate of a first cutting tool in each tool set, transverse and longitudinal cutting tool intervals, and the number of the transverse and longitudinal cutting tools.

4. The compiler of claim 1, wherein the control unit setting module still sets working parameters of the plurality of drilling operations according to a drilling machine type.

5. The compiler of claim 4, further comprising a control unit module, wherein the controlling module is to store grid matrix (GM) and programmable logic controller (PLC) codes of each drilling operation corresponding to a plurality of preset drilling machine types.

6. The compiler of claim 1, wherein the plurality of drilling operations comprises spindle movement, jaw movement, jaw rise, jaw lower, jaw close, jaw open, spindle rise, spindle lower, spindle chuck close, spindle chuck open, spindle turn clockwise, spindle turn anticlockwise, spindle stop, pressure feet lower, pressure foot rise, cutting tool loading, cutting tool unloading, cutting tool deployed in a first tool storage, cutting tool deployed in a second tool storage, and cutting tool offset measurement.

7. The compiler of claim 6, wherein the plurality of working parameters comprises spindle movement speed, jaw movement speed, jaw rise speed, jaw lower speed, spindle rise speed, spindle lower speed, spindle turn clockwise speed, spindle turn anticlockwise speed, pressure feet lower speed, pressure foot rise speed, the location of the cutting tool loading, the location of the cutting tool unloading, the location of the cutting tool deployed in a first tool storage, the location of the cutting tool deployed in a second tool storage, and the location of the cutting tool offset measurement.

8. The compiler of claim 6, wherein the spindle movement and the jaw movement belong to a movement drilling category; wherein the jaw rise, jaw lower, jaw close, jaw open, spindle rise, spindle lower, spindle chuck close, spindle chuck open, spindle turn clockwise, spindle turn anticlockwise, spindle stop, pressure feet lower, pressure foot rise, cutting tool loading, cutting tool unloading, cutting tool deployed in a first tool storage, cutting tool deployed in a second tool storage, and cutting tool offset measurement belong to an assistance drilling category.

9. The compiler of claim 8, wherein a selected drilling machine task is selected from the movement drilling category; wherein, alternatively, the selected drilling machine task is selected from the movement drilling category and the assistance drilling category.

10. The compiler of claim 6, wherein the cutting tool loading, cutting tool unloading, cutting tool deployed in a first tool storage, cutting tool deployed in a second tool storage, and cutting tool offset measurement belong to a location operation category; wherein the spindle movement, jaw movement, jaw rise, jaw lower, jaw close, jaw open, spindle rise, spindle lower, spindle chuck close, spindle chuck open, spindle turn clockwise, spindle turn anticlockwise, spindle stop, pressure feet lower, pressure foot rise belong to an action operation category.

11. The compiler of claim 10, wherein the plurality of drilling operations are graphically displayed; wherein an icon of each drilling operation in the action operation category is corresponding to the source code of each drilling operation in the action operation category; and wherein an icon of each drilling operation in the location operation category is corresponding to location information of each drilling operation in the action location category.

12. The compiler of claim 11, wherein the operation module constitutes the relationship between the drilling operations in the location operation category and the drilling operations in the action operation category based on the abscissas of the drilling operations

13. The compiler of claim 12, the operation module determines the sequence of the source codes for the selected drilling operations in the source program based on the ordinates of the icons of the selected drilling operations.
